(19) United States
(12) Patent Application Publication
(10) Pub. No.: US 2022/0169834 A1
(43) Pub. Date: Jun. 2, 2022

(54) Method for Improving UV Weatherability of Thermoplastic Vulcanizates

(71) Applicant: Celanese International Corporation, Irving, TX (US)

(72) Inventors: Oscar O. Chung, Houston, TX (US); Eric Jourdain, Rhode Saint Genese (BE); Leander M. Kenens, Vlaams Brabant (BE); Hermann Holz, Neuss (DE)

(21) Appl. No.: 17/442,363

(22) PCT Filed: Apr. 17, 2020
(86) PCT No.: PCT/US2020/028774

§ 371 Date: Sep. 23, 2021

Related U.S. Application Data
(60) Provisional application No. 62/835,080, filed on Apr. 17, 2019.

(51) Int. Cl. C08L 7/00; C08J 3/22

(52) U.S. Cl. CPC C08L 7/00; C08J 3/226; C08L 2310/00; C08L 2205/035; C08J 2407/00; C08J 2323/12; C08J 2423/12

(57) ABSTRACT

The present invention describes thermoplastic vulcanizates (TPVs) and methods for forming TPVs that include addition of a masterbatch comprising antioxidant (AO) additives to improve UV weatherability of TPVs. The hindered phenol antioxidants have a melting point of 85° C. or less, and comprise an alkyl chain longer than 12 carbons. A method may comprise compounding a carbon black, carrier resin, and hindered phenol antioxidant to form a masterbatch and dynamically vulcanizing the masterbatch, a vulcanizable elastomer, a thermoplastic resin, and a process oil to yield a TPV.

### CROSS REFERENCE TO RELATED APPLICATIONS

This application claims the benefit to Ser. No. 62/835,080, filed Apr. 17, 2019, the disclosure of which is hereby incorporated by reference in its entirety.

### FIELD

The present disclosure relates to thermoplastic vulcanizates (“TPVs”) with improved weatherability over conventional TPVs, and methods of making the same.

### BACKGROUND

TPVs are a class of thermoplastic compositions that include cross-linked elastomer particles finely dispersed in a continuous thermoplastic phase. TPVs combine the elastomer phase's elastomeric properties with the processability of thermoplastics. The production of TPVs may include the process of dynamic vulcanization. During dynamic vulcanization, the elastomer component is selectively crosslinked (otherwise referred to alternatively as curing or vulcanization) during its melt mixing with the molten thermoplastic under intensive shear and mixing conditions within a blend of at least one non-vulcanizing thermoplastic polymer component while at or above the melting point of that thermoplastic. See, for example, U.S. Pat. Nos. 4,130,535; 4,594,390; 6,147,160; 7,622,528; and 7,935,763, the entirety of each of which is incorporated by reference herein.

TPVs may subsequently be extruded, injected, or otherwise molded by conventional Plastic processing equipment to press and shape TPVs into useful products. These thermoplastic vulcanizates can be made to be lightweight with good aesthetics and excellent durability, and may also be reprocessed at the end of their useful life to produce a new product. For these and other reasons, TPVs are widely used in industrial applications, for example, as auto parts, such as dashboards and bumpers, air ducts, weatherseals, fluid seals, and other under the hood applications; as gears and cogs, wheels, and drive belts for machines; as cases and insulators for electronic devices; as fabric for carpets, clothes, and bedding, and as fillers for pillows and mattresses; and as expansion joints for construction. TPVs are also widely used in consumer goods, being readily processed, capable of coloration as with other plastics, and providing elastic properties that can endow substrate materials, or portions thereof, for instance harder plastics or metals, in multi-component laminates, with a “soft touch” or rebound properties like rubber.

Although TPVs are widely used, the thermoplastics comprising TPV are susceptible to degradation if exposed to ultraviolet (UV) sunlight. UV light exposure leads to cracking, and ultimately disintegration of the polymers. Increasingly, TPVs with improved resistance to ultraviolet waves, or improved UV weatherability, are desired by manufacturers. To combat UV weathering, carbon black may be added to the TPV. See, e.g., KGK-Kautschuk und Gummi Kunststoffe, vol. 54, no. 6, pp. 321-326, 2001. Other methods known to improve UV weatherability include addition of hindered amine light stabilizer compounds (U.S. Pat. No. 5,907,004) and a Lewis base (U.S. Pat. No. 6,051,681), among others. There remains, however, a need for improvements in the UV weatherability of current extrusion grade TPVs, including SANTOPREN® TPVs (thermoplastic elastomers, available from ExxonMobil Corp.), to respond to increased performance demands by manufacturers who use TPVs.

### SUMMARY

The present invention describes TPVs and methods for forming TPVs that include addition of a masterbatch comprising antioxidant (AO) additives to improve UV weatherability of certain TPVs.

A method may comprise compounding a 20 wt. % to 70 wt. % carbon black, 25 wt. % to 75 wt. % carrier resin, and 2 wt. % to 25 wt. % hindered phenol antioxidant to form a masterbatch; and dynamically vulcanizing the masterbatch, a vulcanizable elastomer, a thermoplastic resin, and a process oil to yield a thermoplastic vulcanizate (TPV); Wherein the hindered phenol antioxidant has a melting point of 85° C. or less and comprises an alkyl chain longer than 12 carbons.

A TPV can comprise vulcanizable rubber, a thermoplastic polymer, a masterbatch, a process oil, and a phenolic resin curative; wherein the masterbatch comprises 20 wt. % to 70 wt. % carbon black, 25 wt. to 75 wt. % carrier resin, and 2 wt. % to 25 wt. % hindered phenol antioxidant, wherein the hindered phenol antioxidant has a melting point of 85° C. or less and comprises an alkyl chain longer than 12 carbons.

An example method may comprise introducing to a blender each of a masterbatch comprising 20 wt. % to 70 wt. % carbon black, 25 wt. % to 75 wt. % carrier resin, and 3 wt. % to 25 wt. % hindered phenol antioxidant, a vulcanizable elastomer; a thermoplastic resin; a process oil; and dynamically vulcanizing the masterbatch, thermoplastic resin, and process oil in at least a portion of the vulcanizable elastomer so as to form a thermoplastic vulcanizate (TPV).

### DETAILED DESCRIPTION

The present invention describes TPVs and methods for forming TPVs that include high levels of antioxidant (AO) additives to improve UV weatherability. In order to add AO additives to the TPV for improved UV weatherability, an additional feeder line may be used. However, adding an additional feeder line and constructing additional material handling systems is logistically complex because of the very limited space in the raw material feed area. Additionally, handling of the AO granule or powder can be burdensome to plant operations. Moreover, there is a high cost associated with adding a feeder line. For at least these reasons, methods described herein incorporate AO additives into TPVs via addition to the carbon black masterbatch.

Further, the addition of AO additives in the carbon black masterbatch, which is then incorporated into the TPV formulation, appears to a surprisingly significant improvement in UV weatherability, especially for AO additives having a melting point of 85° C. or less and an alkyl carbon chain length longer than 12 carbon.

The present disclosure describes a method for making TPVs by using masterbatches comprising propylene- or ethylene-based carrier resin, carbon black, and AO additives (e.g., hindered phenols) having a melting point of 85° C. or less and an alkyl carbon chain length longer than 12 carbons. For example, the TPV formulation may comprise an elastomer component, a thermoplastic resin, a process oil, and the masterbatch.

### Definitions and Test Methods

Density of a resin is measured by ASTM D1505-18 at 25° C.

Melt index (MI) is measured by ASTM D1238-13 at 190° C. and 2.16 kg weight for ethylene and ethylene copolymers, and at 230° C. and 2.16 kg weight for propylene and propylene-ethylene copolymers.

As used herein, the term “elastomer” refers to any natural or synthetic polymer exhibiting elastomeric properties, such as rubber.

As used herein, a copolymer of propylene and ethylene is “propylene-based” when propylene-based monomers form the plurality of monomers in the copolymer, based on the total weight of the copolymer (propylene-based monomers are present in the copolymer in larger weight than any other single monomer). Similarly, a copolymer of propylene and ethylene is “ethylene-based” when ethylene-based monomers form the plurality of monomers in the copolymer. Propylene-based copolymers will be indicated by naming propylene first (e.g., “propylene-ethylene copolymers” or “propylene-alpha-olefin in copolymers”), and likewise for ethylene-based copolymers (e.g., “ethylene-propylene copolymers” or “ethylene-alpha-olefin copolymers”). A copolymer of propylene and/or ethylene may optionally include one or more additional comonomers.

As used herein, dynamic vulcanization refers to a process of selectively crosslinking (otherwise referred to alternatively as curing or vulcanizing) the elastomer component during its melt mixing with the molten thermoplastic under intensive shear and mixing conditions within a blend of at least one non-vulcanizing thermoplastic polymer component while at or above the melting point of that thermoplastic. See, for example U.S. Pat. Nos. 4,130,535; 4,594,390; 6,147,160, 7,622,528; and 7,935,763, the entirety of each of which is incorporated by reference herein.

Kinematic viscosities at 40° C. and at 100° C., and viscosity indices are measured in accordance with ASTM D 445-18.

As used herein, the proportion of aromatic carbons (% CA) is the proportion or percentage of the number of aromatic carbon atoms to the number of all carbon atoms as determined by ASTM D2140-17.

The aromatic content of process oils is measured by ASTM D2007-11.

As used herein, “HD” is hardness provided as a Shore A value at 23° C. in accordance with the method as described in ISO 868:2003.

As used herein, “LCR” is a measurement of viscosity in Pa-sec at 1200 sec⁻¹ shear rate using a Lab Capillary Rheometer from DYNISCO®, per the method described in ASTM D3835-16.

As used herein, “ESR” is a measure of the surface smoothness in micro-inch (μin, where 1 μin=25.4 nm) of the TPV, where lower numbers indicate a smoother surface. The ESR was measured using a MAHR FEDERAL® Surfanalyzer (surface analysis system, available from MAHR FEDERAL®) in accordance with the manufacturer's instructions.

“Moisture” is given as a percentage, and is a measurement of the water content of a sample by weight of the total sample.

As used herein, “UTS” is ultimate tensile strength, measured in mPa, and indicates stress-strain elongation properties as measured in accordance with ASTM D790-17.

As used herein, “UE” is ultimate elongation, and indicates the distance, provided as a percentage, a strand of the material can be stretched before it breaks in accordance with ASTM D412-16 (ISO 37 type 2).

As used herein, “M100” is the modulus of the material given in psi/mPa, and the M100 test indicates resistance to strain at 100% extension in force per unit area in accordance with ASTM D412-16 (ISO 37 type 2).

As used herein, “stickiness” signifies whether or not the injection molded plaques have an oily and sticky feel, which was determined by pressing a finger on the surface firmly, and visually observing the finger print when the finger is removed from the surface.

“UV Δ L 3200 hrs” is the change in black to white color, instrumental color un-cleaned surface, CIE Lab L*, a*, b*, D65 at 10° C. excluded.

“UV Δ a 3200 hrs” is the change in in green to red color, instrumental color uncleaned surface, CIE Lab L*, a*, b*, D65 at 10° C. excluded.

“UV Δ b 3200 hrs” is the change in yellow to blue color, instrumental color uncleaned surface, CIE Lab L*, a*, b*, D65 at 10° C. excluded.

“UV Δ E 3200 hrs” is the change of a calculated value ²{square root over ((ΔL²)}+Δa²+Δb²)=ΔE after 3200 hours.

“UV Δ gloss 60°” is the change of the gloss measured by a Gloss meter on unclean surfaces at a 60° angle.

“UV Grayscale” is a measurement of a difference in color between a control sample and a sample exposed to UV weathering conditions for 3200 hours according to the Florida test VW PV 3930 (2008), Kalahari test VW PV 3929 (2008). The difference in color between the specimens is measured against the sections on a grayscale and a corresponding grade is given, with 1 representing the largest change in color and maximum weathering, while 5 is no color change.

### Carbon Black Masterbatch

TPV formulations of the present disclosure are made using a masterbatch comprising about 20 wt. % to about 70 wt. % of carbon black, about 2 wt. % to about 25 wt. % of AO additives (e.g., hindered phenols having a melting point of 85° C. or less and an alkyl carbon chain length longer than 12 carbons), about 25 wt. % to about 75 wt. % of carrier resin, and 0 wt. to 40 wt. % other additives. Typically, the masterbatch is employed as free flowing granules or pellets having a particle size from 100 μm to 5 mm.

Carbon black is a generic term for finely divided carbon manufactured in highly controlled processes to produce specifically engineered aggregates of carbon particles that vary in particle size, aggregate size, shape, porosity, and surface chemistry. The purity of carbon black typically exceeds 95% carbon, with trace amounts of oxygen, hydrogen, nitrogen, and sulfur. The carbon black of the masterbatch of the present disclosure may comprise particles of any conventional type of carbon black (e.g., acetylene black, channel black, furnace black, lamp black, thermal black, and the like, and any combination thereof) produced by incomplete combustion of petroleum products. The size of the carbon black particles has a direct influence on performance properties, such as dispersability, reinforcement, and UV weatherability.

Typical particle sizes (ASTM D3849-14a) may range from about 5 nm to about 330 nm, or from about 5 nm to about 100 nm, or from about 5 nm to about 50 nm, or from about 5 nm to about 25 nm. Preferred particle sizes for improving UV weatherability include, but are not limited to, particle sizes less than about 65 nm, or from about 5 nm to about 65 nm, or about 5 nm to about 40 nm, or about 5 nm to about 20 nm.

Another useful characterization of the carbon black is BET nitrogen absorption surface area, which may be at least about 75 m²/g, or from about 75 m²/g to about 300 m²/g, or from about 100 m²/g to about 250 m²/g, or from about 150 m²/g to about 250 m²/g.

Van der Waals forces may act on carbon black particles to cause the formation of aggregates. Aggregates range in size (e.g., diameter when the aggregate is approximated as a sphere) from about 90 nm to about 900 nm for smaller carbon black particle aggregates, to about 1 micron to about 400 microns for larger carbon black particle aggregates.

As an example carbon black manufacturing method, the Furnace Black method may be employed. The Furnace Black method is a continuous process that uses liquid hydrocarbons as feedstock, and gaseous hydrocarbons as the heat source. Within a refractory-lined furnace, the liquid feedstock is sprayed into a heat source generated by the combustion of natural vas and pre-heated air. The process mixture is subsequently quenched by the injection of water, which prevents any unwanted secondary reactions. The carbon black loaded gas is the passed through a heat exchanger coil to cool, while the process air is heated. A bag filter system separates the carbon black particles from the gas stream, which comprises combustible gases. The gases are fed into an afterburning stage where the heat is used to dry the carbon black, or are burnt in a boiler to form steam. The resulting carbon black with a very low bulk density is collected by a filter, and then frequently pelletized or densified for ease of processing.

The formation of pellets may occur via the wet-pelletizing process, which uses water and a binding agent in a wet pellet or pin mixer. The binding agent serves to prevent attrition and improve processability and movability. The pellets may be dried in rotary dryers. Other methods of manufacturing carbon black include the Degussa gas black process, the lamp black process, the thermal black process, and the acetylene black process, among others.

Carbon black may be incorporated into the masterbatch in the amount of from abort 20 wt. % to about 70 wt. %, or from about 30 wt. % to about 50 wt. %, or from about 35 wt. % to about 45 wt. %, or approximately 40 wt. %, based on the total weight of the masterbatch. The added carbon black imparts a deep jet black color to TPV formulations. Carbon black enhances the properties of TPVs, such as by providing reinforcement, improving resilience, improving tear-strength, imparting UV protection, improved UV weatherability, and improving color retention (preservation of black pigmentation). Carbon black can improve UV weatherability of the TPV by absorbing UV radiation and converting it to heat, stabilizing the TPV formulation, and reducing degradation attributable to sun exposure.

The masterbatch used to form a TPV according to the present disclosure further comprises antioxidants additives like hindered phenols. Hindered phenols are primary antioxidants that scavenge radical intermediates early in the photo-oxidation process. Photo-oxidation is a chain reaction initiated. by exposure of a polymer to UV light that results in the degradation and wearing of the polymer in the TPV. Hindered phenol antioxidants may serve to interrupt the degradation cycle, thereby improving the UV weatherability of polymers into which the antioxidants are incorporated. Hindered phenols may also serve as processing stabilizers that reduce discoloration and improve the retention of useful mechanical properties.

Preferably, the hindered phenols used in the masterbatches, and consequently the TPVs, of the present disclosure are hindered phenols having a melting point of 85° C. or less (or from 30° C. to 85° C., or from 30° C. to 60° C., or from 30° C. to 55° C., or from 35° C. to 55° C.) and an alkyl carbon chain length of 12 or more 12 carbons (e.g., from C12 to C22, from C14 to C20, or from C16 to C18). The alkyl carbon chain can be linear or branched. The alkyl carbon chain can he saturated or unsaturated but is preferably saturated. As used herein, a hindered phenol having (or comprising) an alkyl carbon chain length longer than 12 carbons refers to a molecule that comprises both a hindered phenol group and an alkyl carbon chain (linear or branched; saturated or unsaturated). The hindered phenol having an alkyl carbon chain length longer than 12 carbons can further comprise additional structural components. As used herein, a hindered phenol refers to a phenol comprising (a) a bulky group (e.g., isopropyl, t-butyl) substituted in one or both positions relative to the —OH group and/or one or both of the meta positions relative to the —OH group or (b) a semi-bulky group (e.g., methyl, ethyl) substituted in both ortho positions relative to the —OH group or substituted in one ortho position relative to the —OH with a bulky group substituted according to (a). Other substitutions of the hindered phenol moiety are possible provided the foregoing (a) or (b) is satisfied.

The hindered phenols comprising an alkyl carbon chain length longer than 12 carbons may have a molecular weight from about 325 g/mol to about 1,000 g/mol, or about 325 g/mol to about 600 g/mol, or about 400 g/ mol to about 650 g/mol, or about 500 g/mol to about 1,000 g/mol.

Examples of suitable hindered phenols comprising an alkyl carbon chain length longer than 12 carbons include, but are not limited to, octadecyl-3-(3,5-di-tert.butyl-4-hydroxyphenyl)-propionate (Compound I), α-tocopherols (e.g., vitamin E (Compound II) (also known as (2R)-2,5,7,8-tetramethyl-2-[(4R,8R)-4,8,12-trimethyltridecyl]-3,4-dihydrochromen-6-ol)), β-tocopherols, γ-tocopherols, δ-tocopherols, and the like, and any combination thereof. In the compound drawings below, a solid line box is around the hindered phenol moiety, and a dashed line box is around the alkyl carbon chain moiety having a length longer than 12 carbons.

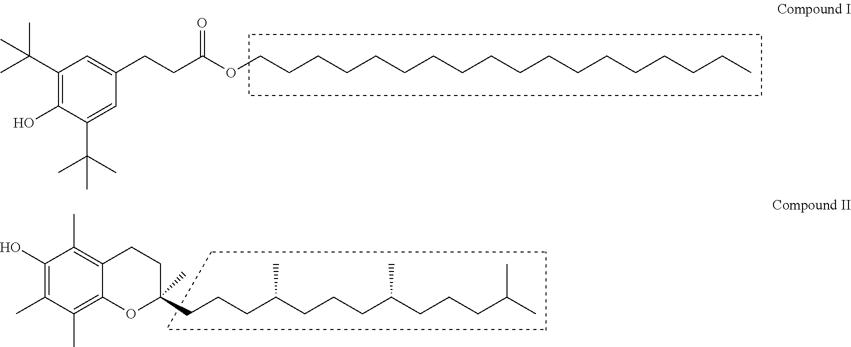

Examples of commercially avail able octadecyl-3-(3,5-di-tert.butyl-4-hydroxyphenyl)-propionate include, but are not limited to, IRGANOX® 1076 (available from BASF SE Co.), ANOX® PP18 (available from Addivant), ETHANOX® 376 (available from SI Group), SONGNOX® 1076 (available from SONGWON Industrial Group), and ADK STAB AO-50 (available from ADEKA Corporation).

The hindered phenol antioxidants described herein may be present in the masterbatch in an amount of 2 wt. % or greater of the masterbatch without adversely affecting the properties of the resulting TPV. For example, the hindered phenol antioxidants described wherein may be present in the masterbatch at about 2 wt. % to about 25 wt. %, or from about 5 wt. % to about 15 wt. %, or from about 8 wt. % to about 12 wt. %, or about 10 wt. %, based on the total weight of the masterbatch.

The carrier resin for the masterbatches described herein can be any conventional or known carrier resin. Examples of carrier resins include, but are not limited to, propylene homopolymers, ethylene-based copolymers, propylene-based copolymers, and the like, and any combination thereof. Examples of suitable carrier resins are described in U.S. Pat. Nos. 4,543,399; 4,588,790; 5,001,205; 5,028,670; 5,317,036; 5,352,749; 5,405,922; 5,436,304; 5,453,471; 5,462,999; 5,616,661; 5,627,242; 5,665,818; 5,668,228; 5,677,375; 7,655,727; 7,964,672; and 10,196,508; PCT publications WO 96/33227 and WO 97/22639; and European publications EP-A-0 794 200, EP-A-0 802 202, and EP-B-634 421, the entire contents of which are incorporated herein by reference.

In general, the carrier resin of the masterbatch may have a density from about 0.850 g/cm³ and about 0.920 g/cm³, or from about 0.860 g/cm³ and about 0.910 g/cm³, or from about 0.850 g/cm³ to about 0.890 g/cm³, or from about 0.880 g/cm³ to about 0.920 g/cm³. The melt index of the carrier resin may be from about 0.05 g/10 min to about 50 g/10 min, or from about 0.1 g/10 min to about 30 g/10 min, or from about 0.1 g/10 min. to about 10 g/10 min, or from about 10 g/10 min to about 20 g/10 min, or from about 20 g/10 min to about 30 g/10 min.

The carrier resin may be present in the masterbatch in an amount of 25 wt. % to about 75 wt. %, or from about 30 wt. % to about 70 wt. %, or from about 40 wt. % to about 60 wt. %, or about 50 wt. %, based on the total weight of the masterbatch.

Optionally, the masterbatch may comprise one or more other additives dispersed within the carrier resin such as fillers, extenders, pigmentation agents, processing aids (e.g., slip agents) and the like. Particular examples include conventional inorganics such as calcium carbonate, clays, silica, talc, titanium dioxide, as well as organic and inorganic nanoscopic filler). Any additive suitable for inclusion in a TPV (particulate or not) may be incorporated into the masterbatch. When present, additives may be included in the masterbatch at 40 wt. % or less, or about 1 wt. % to 40 wt. %, or about 5 wt. % to 25 wt. %, or about 1 wt. % to 10 wt. %, based on the total weight of the masterbatch.

The masterbatch may contain both di-hydrated and anhydrous stannous chloride (SnCl₂) powder, preferably anhydrous SnCl₂, which has a high melting point of approximately 246° C. to 247° C. Any commercially available zinc oxide powder may also be incorporated into the masterbatch. The surface area of ZnO should be at least 8 m²/g, preferably 8 m²/g to 10 m²/g. The amounts of zinc oxide and stannous chloride present in the masterbatch can be varied according to the amount of each additive required in the target dynamic vulcanization process.

### Method of Masterbatch Formation

The masterbatch comprising the presently disclosed TPVs may be formed by any suitable method for blending one or more additive particles with, and dispersing such particles in, a carrier resin. For instance, the additive particles and carrier resin may be dry blended and the mixture subsequently melt-mixed at a temperature above the melting temperature of the carrier resin either directly in an extruder used to make the finished article or by pre-melt mixing in a separate mixer (for example, a BANBURY® mixer available from HF Mixing Group and others). Dry blends of the masterbatch can also be directly injection molded without pre-melt mixture. Examples of machinery capable of generating the shear and mixing include extruders with kneaders or mixing elements with one or more mixing tips or flights, extruders with one or more screws, extruders of co- or counter-rotating type, a COPERION® ZSK twin-screw extruder (available from Coperion Corporation), a BANBURY® mixer, a FCM® Farrell Continuous Mixer (both available from Farrel Corporation, Ansonia Conn.), a BUSS Kneader™ (available from Buss, Inc. USA of Carol Stream, Ill.), and the like. The type and intensity of mixing, temperature, and residence time required can be achieved by the choice of one of the above machines in combination with the selection of kneading or mixing elements, screw design, and screw speed (<3000 rpm). Typically the temperature for melt-mixing is from about 60° C. to about 130° C., and the residence time is from about 10 to about 20 minutes.

Once melt-mixed or otherwise melt-blended, the masterbatch comprising the carbon black, the hindered phenol having a melting point of 85° C. or less and an alkyl carbon chain length longer than 12 carbons, the carrier resin, and optionally other additives may be pelletized by any suitable means, such as strand pelletization or the like. Underwater pelletization (e.g., extruding molten masterbatch into a water bath maintained at a temperature substantially lower than that of the molten extrudate, and pelletizing the masterbatch) may be particularly suited to pelletizing the masterbatch, owing at least in part to the carrier resin propylene-alpha-olefin copolymer's nature. Underwater pelletizing of the masterbatch may be carried out according to the techniques taught in U.S. Pat. No. 8,709,315, the entirety of which is incorporated by reference herein.

The masterbatch may be blended and formed such that the carbon black, hindered phenol antioxidants and/or other additive particles are well-dispersed within the carrier resin, and are substantially non-agglomerated therein.

### TPV

Once formed, the masterbatch described herein may be incorporated into the TPV compositions of the present disclosure. The TPVs may further comprise vulcanizable elastomer, a thermoplastic polymer, a process oil, and a phenolic resin curative. Relative amounts of the various components in TPV formulations are characterized based upon the amount of elastomer in the formulation, given in parts by weight per hundred parts by weight of rubber (phr).

TPV formulations comprise masterbatch (wherein the masterbatch comprises a carbon black, hindered phenol antioxidant, carrier resin, and optionally other additives) in an amount ranging from about 10 phr to about 350 phr, or from about 20 phr to about 100 phr. Where multiple additives (particulate and/or otherwise) are included in the masterbatch, the masterbatch may be present in the TPV formulation in higher amounts, such as from about 55 to about 350 phr, or from about 55 phr to about 200 phr, or from about 150 phr to about 350 phr.

The masterbatch comprising the hindered phenol antioxidant may be included in the TPV in an amount sufficient to achieve a hindered phenol antioxidant concentration in the TPV of from about 0.5 wt. % to about 1.5 wt. %, or from about 0.7 wt. % to about 1.3 wt. %, based on the total weight of the TPV formulation

The elastomer component of TPVs provided herein should be capable of being vulcanized (or cured or cross-linked). Examples of such elastomers may include, but are not limited to, unsaturated non-polar elastomers, monoolefin copolymer elastomers, and the like, and any combination thereof. Monoolefin copolymer elastomers are non-polar, elastomer copolymers of two or more monoolefins (e.g., ethylene, propylene, butene-1, pentene-1, hexene-1, 4-methylpentene-1, 5-methylhexene-1, 4-ethylhexene-1, and the like), which may optionally be copolymerized with at least one polyene, usually a diene. For example, an ethylene-propylene-diene (EPDM) elastomer is a monoolefin copolymer elastomer of ethylene, propylene, and one or more non-conjugated diene(s). Exemplary elastomers are fully described in U.S. Pat. No. 10,196,508, the entirety of which is incorporated by reference herein.

The elastomer component may comprise any one or more other suitable elastomeric copolymer capable of being at least partially vulcanized, whether amorphous, crystalline, or semi-crystalline. Examples of such elastomer components include, but are not limited to, butyl elastomers, natural rubbers, and any other suitable elastomer (synthetic or natural) including those disclosed in U.S. Pat. Nos. 7,935,763 and 8,653,197, the entirety of each of which is hereby incorporated by reference.

The thermoplastic polymer of the TPVs disclosed herein include the thermoplastic polymers described in U.S. Pat. No. 10,196,508, and may furthermore contain additional components, such as any of those additional components described in U.S. Pat. No. 7,935,763 in connection with the thermoplastic resin. For instance, the thermoplastic resin may include additional non-crosslinkable elastomers, including non-TPV thermoplastics and thermoplastic elastomers. Examples include, but are not limited to, polyolefins such as polyethylene homopolymers, and copolymers with one or more C₃-C₈ alpha-olefins. Exemplary thermoplastic polymers may be polyethylene, polypropylene, an ethylene alpha-olefin copolymer, a polypropylene random copolymer, a propylene-based elastomer, or any combination thereof. Elastomers, especially those in the high end of the molecular weight range, are often oil extended in the manufacturing process and can be directly processed as such in accordance with the present disclosure. For example, an elastomer component included in a TPV of the present disclosure may comprise both elastomer and extender oil.

TPV formulations may include the thermoplastic resin in an amount from about 20 phr to about 300 phr, from about 30 phr to about 300 phr, or from about 50 phr to about 250 phr, or from about 100 phr to about 150 phr. Increasing amounts of thermoplastic resin may correspond to increasing hardness of the dynamically vulcanized TPV.

In general, suitable process oils incorporated in the TPV may include any process oil described in U.S. Pat. No. 10,240,008, the entirety of which is incorporated herein by reference. Further, process oils may be present in any proportion(s) described therein. The process oils can be made by any process known in the art. Further description of the process to produce the oil may be found in U.S. Pat. Nos. 6,261,441 B1 and 4,383,913, the contents of which are incorporated herein by reference.

Generally, the process oil in the thermoplastic vulcanizate may be selected from (i) extension oil, that is oil present in an oil-extended rubber, (ii) free oil, that is oil that is added during the vulcanization process, (iii) curative-in-oil, that is oil that is used to dissolve/disperse the curative, for example, a curative-in-oil dispersion such as a phenolic resin-in-oil, and/or (iv) any combination of oils from (i), (ii), and (iii). The extension oil, the free oil, and the curative-in-oil may be the same or different oils. The extension oil, free oil, and curative-in-oil are all low aromatic/low sulfur process oils. Optionally, only one of the extension oil, free oil, or curative-in-oil may be low aromatic/low sulfur process oils while the other two types of oil are not. Two of the process oils selected from extension oil, free oil, or curative-in-oil may be low aromatic/low sulfur process oil while the other type of oil may not be.

The process oil used in the TPVs described herein may comprise a mineral oil, or any hydrocarbon liquid of lubricating viscosity (a kinematic viscosity at 100° C. of 1 mm²/sec. or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. By way of non-limiting example, the process oil may be PARALUX® or PARAMOUNT® (process oils, available from Chevron Corp.). Illustrative paraffinic oils are described in U.S. Pat. No. 7,615,589, the contents of which is incorporated herein by reference. Exemplary process oils may be a Group II oil, which is an oil having saturate content exceeding 90 wt. % of the TPV, a sulfur content of less than or equal to 0.03 wt. % of the TPV, and a viscosity index between 80 and 119. The process oil may also be a hydrotreated heavy paraffinic.

The process oil may be present in the TPV in an amount such that the weight ratio of the process oil to the rubber is from about 0.5:1 to about 2:1, or from about 0.8:1 to about 1.8:1. In the TPVs described herein, at least a portion of the process oil is a low aromatic/low sulfur process oil that has (i) an aromatic content of less than about 5 wt. % by weight of the TPV composition, or less than about 3.5 wt. %, or less than about 2 wt. %, or less than about 1.5 wt. %, or less than about 1 wt. %, and (ii) a sulfur content of less than 0.03 wt. %, or less than about 0.02 wt. %, or less than about 0.01 wt. %, or less than about 0.005 wt. %. The percentage of aromatic carbon in the process oil may be less than 2% CA, or less than 1% CA, or less than 0.5% CA, or may be 0% CA.

An extension oil may be present in the TPV in an amount of from 10 wt. % to 50 wt. %, or from 12 wt. % to 40 wt. %, or from 15 wt. % to 30 wt. %, based on the weight of the TPV, where ranges from any lower limit to any upper limit are contemplated. The free process oil may be present in the TPV in an amount of from 5 wt. % to 30 wt. %, or from 7 wt. % to 25 wt. %, or from 10 to 20 wt. %, based on the weight of the TPV, where ranges from any lower limit to any upper limit are contemplated. The oil in the curative-in-oil may be present in the TPV in an amount of from 0.2 wt. to 5 wt. %, or from 0.3 wt. % to 4 wt. %, or from 0.4 wt. % to 3 wt. %, or from 0.5 wt. % to 2.5 wt. %, or from 0.7 wt. % to 2 wt. %, based on the weight of the TPV, where ranges from any lower limit to any upper limit are contemplated.

Optionally, at least 30 wt. %, or at least 40 wt. %, or at least 50 wt. %, or at least 55 wt. %, or at least 60 wt. %, or at least 65 wt. %, or at least 70 wt. %, or at least 75 wt. %, or at least 80 wt. %, or at least 85 wt. %, or at least 90 wt. %, or at least 95 wt. %, or at least 100 wt. %, of the process oil in the TPV is a low aromatic/low sulfur content process oil.

The thermoplastic vulcanizate formulations may optionally further comprise one or more additives in addition to the masterbatch. Suitable additional TPV additives include, but are not limited to, plasticizers, fillers, processing aids, acid scavengers, and/ or the like. The thermoplastic elastomers of the present invention may include mixtures of various branched or various linear polymeric processing additives, as well as mixtures of both linear and branched polymeric processing additives. Thermoplastic vulcanizates that include similar processing additives are disclosed in U.S. Pat. No. 6,451,915, which is incorporated herein by reference.

The thermoplastic vulcanizate formulations may comprise a vulcanizing agent. Any vulcanizing agent that is capable of curing or crosslinking the rubber employed in preparing the TPV may be used. For example, where the rubber includes an olefinic elastomeric copolymer, the cure agent may include peroxides, phenolic resins, free radical curatives, or other curatives conventionally employed.

In preferred embodiments, the TPV is cured using a phenolic resin vulcanizing agent. The preferred phenolic resin curatives can be referred to as resole resins, which are made by the condensation of alkyl substituted phenols or unsubstituted phenols with aldehydes, preferably formaldehydes, in an alkaline medium or by condensation of bi-functional phenoldialcohols. The alkyl substituents of the alkyl substituted phenols may contain 1 to about 10 carbon atoms. Dimethylolphenols or phenolic resins, substituted in para-positions with alkyl groups containing 1 to about 10 carbon atoms are preferred. In some embodiments, a blend of octyl phenol and nonylphenol-formaldehyde resins are employed. The blend may include from about 25 wt. % to about 40 wt. % octyl phenol, and from about 75 wt. % to about 60 wt. % nonylphenol more preferably, the blend includes from about 30 wt. % to about 35 wt. % octyl phenol and from about 70 wt. % to about 65 wt. % nonylphenol. In some embodiments, the blend includes about 33 wt. % octylphenol-formaldehyde and about 67 wt. % nonylphenol formaldehyde resin, where each of the octylphenol and nonylphenol include methylol groups. This blend can be solubilized in paraffinic oil at about 30% solids.

Useful phenolic resins may be obtained under the tradenames SP-1044, SP-1045 (Schenectady International; Schenectady, N.Y.), which may be referred to as alkylphenol-formaldehyde resins (also available in a 30/70 weight percent paraffinic oil solution under the trade name HRJ-14247A). SP-1045 is believed to be an octylphenol-formaldehyde resin that contains methylol groups. The SP-1044 and SP-1045 resins are believed to be essentially free of halogen substituents or residual halogen compounds. By “essentially free of halogen substituents,” it is meant that the synthesis of the resin provides for a non-halogenated resin that may only contain trace amounts of halogen containing compounds.

Preferred phenolic resin may have a structure according to the following general formula:

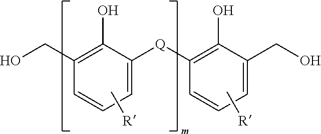

where Q is a divalent radical selected from the group consisting of —CH2- and CH2-O—CH2-; m is zero or a positive integer from 1 to 20; and R′ is an alkyl group. Preferably, Q is the divalent radical —CH2-O—CH2-, m is zero or a positive integer from 1 to 10, and R′ is an alkyl group having fewer than 20 carbon atoms. Still more preferably, m is zero or a positive integer from 1 to 5 and R′ is an alkyl group having between 4 and 12 carbon atoms.

Other examples of suitable phenolic resins include those described in U.S. Pat. Nos. 8,207,279 and 9,399,709.

The curative may be used in conjunction with a cure accelerator, a metal oxide, an acid scavenger, and/or polymer stabilizers. Useful cure accelerators include metal halides, such as stannous chloride, stannous chloride anhydride, stannous chloride dihydrate and ferric chloride. The cure accelerator may be used to increase the degree of vulcanization of the TPV, and in some embodiments may be added in an amount of less than 1 wt. % based on the total weight of the TPV. In preferred embodiments, the cure accelerator comprises stannous chloride. In some embodiments, the cure accelerator is introduced into the vulcanization process as part of a masterbatch.

In some embodiments, metal oxides may be added to the vulcanization process. It is believed that the metal oxide can act as a scorch retarder in the vulcanization process. Useful metal oxides include zinc oxides having a mean particle diameter of about 0.05 μm to about 0.15 μm. Useful zinc oxide can be obtained commercially under the tradename Kadox™ 911 (Horsehead Corp).

The curative, such as a phenolic resin, may be introduced into the vulcanization process in a solution or as part of a dispersion. In preferred embodiments, the curative is introduced to the vulcanization process in an oil dispersion/solution, such as a curative-in-oil or a phenolic resin-in-oil, where the curative/resin is dispersed and/or dissolved in a process oil. The process oil used may be a mineral oil, such as an aromatic mineral oil, naphthenic mineral oil, paraffinic mineral oils, or combination thereof In preferred embodiments, the process oil used is a low aromatic/sulfur content oil, as described herein, that has (i) an aromatic content of less than 5 wt. %, or less than 3.5 wt. %, or less than 1.5 wt. %, based on the weight of the low aromatic/sulfur content oil, and (ii) a sulfur content of less than 0.03 wt. %, or less than 0.003 wt. based on the weight of the low aromatic/sulfur content oil.

The method of dispersing and/or dissolving the curative, such as a phenolic resin, in the process oil may he any method known in the art. For example, in some embodiments, the phenolic resin and process oil, such as a mineral oil and/or a low aromatic/sulfur content oil, may be fed together into a glass container equipped with a stirrer and heated while stirring on a water bath of 60° C. to 100° C. for 1 to 10 hours, as described in U.S. Pat. No. 9,399,709. For example, in other embodiments, the resin-in-oil dispersion may be made as part of the process for producing the phenolic resin, where the oil is a diluent in the manufacturing process.

In addition, TPV formulations of the present disclosure may include reinforcing and non-reinforcing fillers, lubricants, antiblocking agents, anti-static agents, waxes, foaming agents, pigments, flame retardants, and other processing aids known in the rubber compounding art. These additives can comprise up to about 50 wt. % of the total TPV composition. Fillers and extenders that may be utilized include conventional inorganics such as calcium carbonate, clays, silica, talc, titanium dioxide, as well as organic and inorganic nanoscopic fillers. TPV additives or fillers may be added in their own separate additional masterbatches (e.g., with one or more additional TPV additives per such additional masterbatch). Each additional masterbatch may comprise a carrier resin according to the carrier resin of any of the masterbatches discussed above, including a conventional carrier resin.

The TPV formulation may include acid scavengers. These acid scavengers may be added to the thermoplastic vulcanizates after the desired level of cure has been achieved. The acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃.4H₂. Synthetic hydrotalcite compounds, which are believed to have the formula: Mg_{4.3}Al₂(OH)_{12.6}CO₃.mH₂O or Mg_{4.5}Al₂(OH)₁₃CO₃.3.5H₂O, can be obtained under the tradenames DHT-4A® or KYOWAAD™ 1000 (polymer addition agents, available from Kyowa; Japan), Another commercial example is that available under the trade name ALCAMIZER® (halogen polymer stabilizer, available from Kyowa).

The amount of hindered phenol antioxidant present in the resulting TPV formulations, whether added through the masterbatch, EPDM rubber, PP resin, and other additive masterbatches, and/or through any other means, is in aggregate from about 0.5 wt. % to about 1.5 wt. %, or from about 0.7 wt. % to about 1.3 wt. %, based on the total weight of the TPV formulation.

### Method of Processing TPV Formulations

The thermoplastic vulcanizates may be prepared by processing of the TPV formulation, such as by means of dynamic vulcanization. Dynamic vulcanization refers to a vulcanization (cross-linking or curing) process for an elastomer contained in a blend that includes the elastomer, curatives, and at least one thermoplastic resin. The elastomer is vulcanized under conditions of shear and extension at a temperature at or above the melting point of the thermoplastic resin. The elastomer is thus simultaneously crosslinked and dispersed (optionally as fine particles) within the thermoplastic resin matrix, although other morphologies, such as co-continuous morphologies, may exist depending on the degree of cure, the elastomer to plastic viscosity ratio, the intensity of mixing, the residence time, and the temperature.

Processing may include melt blending, in a blender, a TPV formulation comprising the elastomer component, thermoplastic resin, and masterbatch. The blender may be any vessel that is suitable for blending the selected composition under temperature and shearing force conditions necessary to form a thermoplastic vulcanizate. In this respect, the blender may be a mixer, such as a BANBURY® mixer, or a mill, or an extruder. The blender may be an extruder, which may be a single or multi-screw extruder. The term “multi-screw extruder” means an extruder having two or more screws; with two and three screw extruders being exemplary, and two or twin screw extruders being optionally used. The screws of the extruder may have a plurality of lobes; two and three lobe screws being optionally used. It will readily be understood that other screw designs may be selected in accordance with the methods of the present invention. Dynamic vulcanization may occur during and/or as a result of extrusion.

The dynamic vulcanization of the elastomer may be carried out so as to achieve relatively high shear, as defined in U.S. Pat. No. 4,594,390, which is incorporated herein by reference. The mixing intensity and residence time experienced by the ingredients during dynamic vulcanization may be greater than that proposed in U.S. Pat. No. 4,594,390. The blending may be performed at a temperature not exceeding about 400° C., or not exceeding about 300° C., or not exceeding about 250° C. The minimum temperature at which the melt blending is performed is generally higher than or equal to about 130° C. or higher than or equal to about 150° C. or higher than or equal to about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization may include phase inversion. As those skilled in the art appreciate, dynamic vulcanization may begin by including a greater volume fraction of rubber than thermoplastic resin. As such, the thermoplastic resin may be present as the discontinuous phase when the rubber volume traction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Masterbatch, hindered phenol antioxidants, and any other additive(s) may be present within the TPV formulation when dynamic vulcanization is carried out, although masterbatch, hindered phenol antioxidants, and/or any one or more other additives (if any) may be added to the composition after the curing and/or phase inversion (e.g., after the dynamic vulcanization portion of processing). Masterbatch and/or other additional ingredients may be included after dynamic vulcanization by employing a variety of techniques. The masterbatch and/or other additional ingredients can be added while the thermoplastic vulcanizate remains in its molten state from the dynamic vulcanization process. For example, the additional ingredients can be added downstream of the location of dynamic vulcanization within a process that employs continuous processing equipment, such as a single or twin screw extruder. The thermoplastic vulcanizate can be “worked-up” or pelletized, subsequently melted, and the additional ingredients can be added to the molten thermoplastic vulcanizate product. This latter process may be referred to as a “second pass” addition of the ingredients.

The TPV in molten form may be passed through a screen pack comprising one or more mesh screens at any point after dynamic vulcanization. The screen pack may comprise a 100 Standard U.S. Mesh screen (a mesh screen having 100 openings as measured across one linear inch of the mesh), or a finer screen (a screen having a larger number of openings in one inch than a 100 U.S. mesh screen, such as a 230 U.S. mesh screen, 270 U.S. mesh screen, 325 U.S. mesh screen, or 400 U.S. mesh screen). The screen pack may comprise multiple screens.

The TPV may be passed through the screen pack directly after dynamic vulcanization, or it may be passed through the screen pack at any other point in which the composition is in a molten state (e.g., during a second pass addition of other ingredients). Advantageously, passing the TPV through such a screen pack may enhance surface smoothness of the resulting TPV after extrusion or other processing.

Despite the fact that the elastomer may be partially or fully cured, the compositions of this invention can be processed and reprocessed by conventional plastic processing techniques such as extrusion, injection molding, and compression molding. The rubber within these thermoplastic elastomers is usually in the form of finely-divided and well-dispersed particles of vulcanized or cured rubber within a continuous thermoplastic phase or matrix, although a co-continuous morphology or a phase inversion is also possible.

### Resulting Thermoplastic Vulcanizate

The resulting TPV may accordingly be characterized as comprising the compounded reaction product of the ingredients forming the TPV formulation following processing of those ingredients, wherein the processing includes dynamic vulcanization.

The TPV comprises the cured elastomer in the form of finely-divided and well-dispersed particles within the thermoplastic medium. Put another way, the TPV comprises a disperse phase (comprising the at least partially cured elastomer component) in a continuous phase (comprising the thermoplastic resin). Optionally, the elastomer particles have an average diameter that is less than 50 micrometers, or less than 30 micrometers, or less than 10 micrometers, or less than 5 micrometers or less than 1 micrometer. Optionally, at least 50%, or at least 60%, or at least 75% of the particles have an average diameter of less than 5 micrometers, or less than 2 micrometers, or less than 1 micrometer.

The elastomer in the resulting TPV is completely or fully cured. The degree of cure can be measured by determining the amount of rubber that is extractable from the thermoplastic vulcanizate by using boiling xylene as an extractant. This method is disclosed in U.S. Pat. No. 4,311,628, which is incorporated herein by reference. The rubber has a degree of cure where not more than 15 wt. %, or not more than 10 wt. %, or not more than 5 wt. %, or not more than 3 wt. % is extractable by boiling xylene as described in U.S. Pat. Nos. 5,100,947 and 5,157,081, which are incorporated herein by reference. Alternatively, the rubber has a degree of cure such that the crosslink density is at least 4×10⁻⁵, or at least 7×10⁻⁵, or at least 10×10⁻⁵ moles per milliliter of elastomer.

All numerical values within the detailed description and the claims herein are modified by “about” or “approximately” with respect to the indicated value, and take into account experimental error and variations that would be expected by a person having ordinary skill in the art.

As used in the present “disclosure and claims, the singular forms “a,” “an,” and “the” shall include plural forms unless the context clearly dictates otherwise.

The term “and/or” as used in a phrase such as “A and/or B” herein is intended to include “A and B,” “A or B,” “A,” and “B.”

To facilitate a better understanding of the embodiments of the present invention, the following examples of preferred or representative embodiments are given. In no way should the following examples be read to limit, or to define, the scope of the invention.

### EXAMPLES

The incorporation of hindered phenol antioxidants into the resulting TPV at levels exceeding 0.5% by weight improves UV weatherability of TPVs.

### Example 1

TPVs were made using hindered phenol antioxidants (AO) added separately and incorporated into the masterbatch (MB). Hindered phenol antioxidants used were IRGANOX® 1076FD (IR 1076) and IRGANOX® 1010 (IR 1010). UV weatherability was tested using accelerated weathering test methods according to the Florida test, VOLKSWAGEN® PV 3930 (2008); Kalahari test, VOLKSWAGEN® PV 3929 (2008). Higher moisture levels in pellets is associated with thermal degradation of TPVs when heated for processing.

Other components of the TPVs tested below (TABLE 1) include V3666B rubber, a vulcanizable elastomer; ICECAP-K® clay (anhydrous aluminum silicate clay, available from Burgess Pigment Company); ZOCO 102 zinc oxide, an activator in the vulcanization process; POLYONE® (colorant, available from Polyone Corporation) SnCl₂ MB, a stannous chloride masterbatch; EXXONMOBIL® PP5341 PP, a homopolymer resin; Cabot PP6331 black MB, a polypropylene (PP) carrier based masterbatch containing 40% carbon black; IRGANOX® 1076FD, a hindered phenol antioxidant; Cabot black MB (CBMB) with varying weight percentages of antioxidant (AO), IR 1076 or IR 1010; HRJ 16261 RIO, a phenolic resin in oil (RIO); PARAMOUNT® 6001 oil #1, a process oil; and PARAMOUNT® 6001 oil 42, a process oil.

Results of the UV weatherability test may be found in TABLE 1.

TABLE 1

| TPV component | NO AO | AO1 | AO2 | AO3 | NO AO | MB1 | MB2 | MB3 | MB4 |
|---|---|---|---|---|---|---|---|---|---|
| V3666B Rubber (phr) | 175 | 175 | 175 | 175 | 175 | 175 | 175 | 175 | 175 |
| ICECAP-K ® Clay (phr) | 42 | 42 | 42 | 42 | 42 | 42 | 42 | 42 | 42 |
| Zoco 102 Zinc Oxide (phr) | 1.5 | 1.5 | 1.5 | 1.5 | 1.5 | 1.5 | 1.5 | 1.5 | 1.5 |
| POLYONE ® SnCl₂ MB (phr) | 2.17 | 1.67 | 1.67 | 1.67 | 1.67 | 1.67 | 1.67 | 1.67 | 1.67 |
| EM PP5341 PP (phr) | 214.65 | 214.65 | 214.65 | 214.65 | 214.65 | 214.65 | 214.6 | 214.6 | 214.6 |
| Cabot PP6331 black MB (phr) | 36.61 | 36.61 | 36.61 | 36.61 | 45 | | | | |
| IR 1076FD (phr) | — | 2.5 | 5 | 9.45 | — | — | — | — | — |
| CBMB 5% AO (phr) | — | — | — | — | — | 50 | — | — | — |
| CBMB 10% AO (phr) | — | — | — | — | — | — | 50 | — | — |
| CBMB 15% IR1076 (phr) | — | — | — | — | — | — | — | 50 | — |
| CBMB 10% IR1010 (phr) | — | — | — | — | — | — | — | — | 50 |
| HRJ 16261 RIO (phr) | 12.83 | 12.83 | 12.83 | 12.83 | 12.83 | 12.83 | 12.83 | 12.83 | 12.83 |
| Paramount 6001 Oil #1 (phr) | 4.92 | 4.92 | 4.92 | 4.92 | 4.92 | 4.92 | 4.92 | 4.92 | 4.92 |
| Paramount 6001 Oil #2 (phr) | 44.58 | 44.58 | 44.58 | 44.58 | 44.58 | 44.58 | 44.58 | 44.58 | 44.58 |
| Total (phr) | 534.26 | 536.26 | 538.76 | 543.21 | 542.15 | 547.15 | 547.15 | 560.15 | 547.15 |
| HD (Shore A value at 23° C.) | 40.2 | 43.2 | 43.9 | 39.4 | 40.5 | 39.2 | 41 | 42.1 | 42.8 |
| LCR (Pa-sec at 1200 sec⁻¹ shear rate) | 97.58 | 95.82 | 97.06 | 95.33 | 97.92 | 94.64 | 92.9 | 92.59 | 94.54 |
| ESR (micro-inch) | 38.8 | 43.2 | 43.4 | 46 | 52.9 | 17.5 | 21 | 18.2 | 24.3 |
| Moisture (%) | 0.0186 | 0.022 | 0.021 | 0.0212 | 0.0235 | 0.0111 | 0.01 | 0.0106 | 0.0105 |
| UTS (mPa) | 15.09 | 15.91 | 17.09 | 16.33 | 15.86 | 15.47 | 16.24 | 16.11 | 17.12 |
| UE (%) | 575 | 580 | 613 | 603 | 600.00 | 538.00 | 577 | 571 | 627 |
| M100 (psi/mPa) | 8.88 | 8.87 | 9.03 | 8.99 | 9.23 | 9.21 | 9.39 | 9.71 | 9.27 |
| Stickiness | None | None | None | None | None | None | None | None | Yes |
| UV Δ L 3200 hrs | 1.8 | 1.94 | 2.5 | 3.73 | 1.18 | 0.7 | 0.56 | 0.42 | −0.73 |
| UV Δ a 3200 hrs | −0.02 | −0.07 | −0.04 | −0.05 | −0.09 | −0.06 | −0.04 | −0.05 | 0.06 |
| UV Δ b 3200 hrs | 0.59 | 0.33 | 0.46 | 0.59 | 0.45 | 0.35 | 0.48 | 0.6 | 0.97 |
| UV Δ E 3200 hrs | 1.89 | 1.97 | 2.54 | 3.78 | 1.27 | 0.78 | 0.74 | 0.73 | 1.77 |
| UV Δ gloss 60° | −0.32 | −0.09 | −0.07 | −0.11 | −0.06 | 0.14 | 0.10 | −0.31 | −0.82 |
| UV Grayscale | 4 | 4 | 4 | 4 | 4.5 | 4.5 | 4.5 | 4.5 | 4.5 |

As shown in TABLE 1, addition of hindered phenols having a melting point of 85° C. or less and an alkyl carbon chain length longer than 12 carbons (MB1-MB3) improves the UV weatherability of TPVs. Further illustrated is a hindered phenol not meeting such requirements (e.g., IRGANOX® 1010) produces a TPV (MB4) that is sticky and difficult to process and does not have improved UV weatherability like the hindered phenols having a melting point of 85° C. or less and an alkyl carbon chain length longer than 12 carbons (MB1-MB3).

All documents described herein are incorporated by reference herein for purposes of all jurisdictions where such practice is allowed, including any priority documents and/or testing procedures to the extent the documents, including any priority documents and/or testing procedures, are not inconsistent with this text. As is apparent from the foregoing general description and the specific embodiments, while forms of the disclosure have been illustrated and described, various modifications can be made without departing from the spirit and scope of the disclosure. Accordingly, Applicant does not intend that the disclosure be limited thereby. For example, the compositions described herein may he free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the upper and lower limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that the indefinite article a or an introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method comprising:
compounding a 20 wt. % to 70 wt. % carbon black, 25 wt. % to 75 wt. % carrier resin, and 2 wt. % to 25 wt. % hindered phenol antioxidant to form a masterbatch; and
dynamically vulcanizing the masterbatch, a vulcanizable elastomer, a thermoplastic resin, and a process oil to yield a thermoplastic vulcanizate (TPV); wherein the hindered phenol antioxidant has a melting point of 85° C. or less and comprises an alkyl chain longer than 12 carbons.

2. The method of claim 1, wherein the hindered phenol antioxidant comprises one selected from the group consisting of octadecyl-3-(3,5-di-tert-butyl-4-hydroxyphenyl)-propionate, α-tocopherol, β-tocopherol, γ-tocopherol, δ-tocopherol, and any combination thereof.

3. The method of claim 1, wherein the hindered phenol antioxidant is present in the TPV at 0.5 wt. % to 1.5 wt. % based on a total weight of the TPV.

4. The method of claim 1, wherein the melting point of the hindered phenol antioxidant is below 60° C.

5. The method of claim 1, wherein the alkyl chain of the hindered phenol antioxidant is C13 to C22.

6. The method of claim 1, wherein the alkyl chain of the hindered phenol antioxidant is saturated.

7. The method of claim 1, wherein the process oil comprises one or more of a Group II base oil and/or a Group II base oil resin-in-oil.

8. The method of claim 1, wherein the process oil is a hydrotreated heavy paraffinic.

9. The method of claim 1, wherein the thermoplastic resin is selected from the group consisting of polyethylene, polypropylene, an ethylene alpha-olefin copolymer, a polypropylene random copolymer, a propylene-based elastomer, and any combination thereof.

10. The method of claim 1, wherein the vulcanizable elastomer is selected from the group consisting of natural rubbers, synthetic rubbers, and any combination thereof.

11. The method of claim 1, wherein the carrier resin is a homopolypropylene.

12. The method of claim 1, wherein the mixing and dynamically vulcanizing are carried out in a mixer, a mill, or an extruder.

13. A TPV comprising:
vulcanizable rubber, a thermoplastic polymer, a masterbatch, a process oil, and a phenolic resin curative;
wherein the masterbatch comprises 20 wt. % to 70 wt. % carbon black, 25 wt. % to 75 wt. % carrier resin, and 2 wt. % to 25 wt. % hindered phenol antioxidant, wherein the hindered phenol antioxidant has a melting point of 85° C. or less and comprises an alkyl chain longer than 12 carbons.

14. The TPV of claim 13, wherein the hindered phenol antioxidant comprises one selected from the group consisting of octadecyl-3-(3,5-di-tert-butyl-4-hydroxyphenyl)-propionate, α-tocopherol, β-tocopherol, γ-tocopherol, δ-tocopherol, and any combination thereof.

15. The TPV of claim 13, wherein the hindered phenol antioxidant is present in the TPV at 0.5 wt. % to 1.2 wt. % based on a total weight of the TPV.

16. The TPV of claim 13, wherein the melting point of the hindered phenol antioxidant is from 30° C. to 60° C.

17. The TPV of claim 13, wherein the alkyl chain of the hindered phenol antioxidant is C13 to C22.

18. The TPV of claim 13, wherein the alkyl chain of the hindered phenol antioxidant is saturated.

19. A method comprising:
introducing to a blender each of
a masterbatch comprising 20 wt. % to 70 wt. % carbon black, 25 wt. % to 75 wt. % carrier resin, and 3 wt. % to 25 wt. % hindered phenol antioxidant;
a vulcanizable elastomer;
a thermoplastic resin;
a process oil; and
dynamically vulcanizing the masterbatch, thermoplastic resin, and process oil in at least a portion of the vulcanizable elastomer so as to form a thermoplastic vulcanizate (TPV).

20. The method of claim 19, further comprising introducing to the blender one or more additives selected from the group consisting of plasticizers, process oils, fillers, processing aids, acid scavengers, and any combination thereof.

21. The method of claim 19, further comprising mixing the vulcanizable elastomer and the masterbatch above the melt temperature of the thermoplastic resin.

22. The method of claim 19, wherein the blender is selected from the group consisting of a mixer, a mill, and an extruder.

23. The method of claim 19, further comprising the steps of introducing to the blender each of kaolin and zinc oxide powder prior to dynamic vulcanization.
